(19) United States
(12) Patent Application Publication
(10) Pub. No.: US 2026/0323241 A1
(43) Pub. Date: Oct. 15, 2026

(54) DETERMINING EARLY REFLECTION PARAMETERS

(71) Applicant: Nokia Technologies Oy, Espoo (FI)

(72) Inventors: Antti Johannes Eronen, Tampere (FI); Mikko-Ville Laitinen, Espoo (FI); Archontis Politis, Tampere (FI)

(21) Appl. No.: 19/476,229

(22) PCT Filed: Apr. 8, 2024
(86) PCT No.: PCT/EP2024/059451

§ 371 Date: Oct. 17, 2025

(30) Foreign Application Priority Data
Apr. 19, 2023 (GB) 2305721.9

(51) Int. Cl. H04S 7/00

(52) U.S. Cl. CPC H04S 7/306

(57) ABSTRACT

A method for reproduction of at least one reflection of reverberation in virtual acoustics rendering systems, the method including: obtaining for a room, a geometry of the room and a reverberation time parameter; determining a room absorption area based on the determined reverberation time parameter and the geometry of the room; assigning absorption coefficients for at least one surface of the room based on the determined room absorption area; and rendering the at least one early reflection based on the determined absorption coefficients.

### FIELD

The present application relates to apparatus and methods for determining early reflection parameters, but not exclusively for determining early reflection parameters from spatial room impulse responses and room geometry.

### BACKGROUND

Reverberation refers to the persistence of sound in a space after the actual sound source has stopped. Different spaces are characterized by different reverberation characteristics. For conveying spatial impression of an environment, reproducing reverberation perceptually accurately is important. Room acoustics are often modelled with individually synthesized early reflection portion and a statistical model for the diffuse late reverberation. FIG. 1 depicts an example of a synthesized room impulse response where the direct sound 101 is followed by discrete early reflections 103 which have a direction of arrival (DOA) and diffuse late reverberation 105 which can be synthesized artificially, matching the temporal, spectral and directional statistics of an actual late reverberation of a real or virtual acoustic space. The delay d1(t) 102 in FIG. 1 can be seen to denote the direct sound arrival delay from the source to the listener and the delay d2(t) 104 can denote the delay from the source to the listener for one of the early reflections (in this case the first arriving reflection). In such an example after the direct sound, the listener hears directional early reflections. After some point, individual reflections can no longer be perceived but the listener hears diffuse, late reverberation.

The late reverberation can be rendered using, e.g., a Feedback-Delay-Network (FDN) reverberator with a suitable tuning of delay line lengths. FDNs enable control of reverberation times (RT60) and the energies of different frequency bands individually. Thus, the FDN can be used to render the reverberation based on the characteristics of the room. Furthermore the reverberation times and the energies of the different frequencies are affected by the frequency-dependent absorption characteristics of the room.

Early reflections can be rendered, for example, as delayed and filtered copies of the original signal modelling specular reflections emanating as the original signal reflects from walls. However, if a recording is performed in a real room (e.g., by reproducing a test signal through a loudspeaker) and then the same signal is rendered as an object signal with a simulation of the room, then the simulated result does not produce an equal quality output with current computationally efficient (i.e., suitable for real-time interactive rendering) methods.

### SUMMARY

There is provided according to a first aspect a method for reproduction of at least one reflection of reverberation in virtual acoustics rendering systems, the method comprising: obtaining for a room, a geometry of the room and at least one spatial room impulse response, wherein the at least one spatial room impulse response is obtained based on a measurement in the room; determining a reverberation time parameter based on the at least one spatial room impulse response; determining a room absorption area based on the determined reverberation time parameter and the geometry of the room; determining at least one parameter of early reflections from the at least one spatial room impulse response based on at least one image source position, wherein the at least one image source position is associated with early reflections of the at least one spatial room impulse response; extracting at least one reflection from the at least one spatial room impulse response; extracting at least one reflection coefficient based on the extracted at least one reflection for at least one surface of the room; assigning absorption coefficients for at least one surface of the room based on the at least one reflection coefficient and the determined room absorption area; and rendering the at least one early reflection based on the determined absorption coefficients.

Determining at least one parameter may comprise determining at least one of: a time of early reflections from the at least one spatial room impulse response based on at least one image source position; and a direction of arrival of early reflections from the at least one spatial room impulse response based on at least one image source position.

Extracting at least one reflection from the at least one spatial room impulse response may comprise applying a beamforming to the measured at least one spatial room impulse response to extract at least one reflection.

Obtaining for the room, at least one spatial room impulse response may comprise measuring the at least one spatial room impulse response in the room.

The at least one spatial room impulse response may comprise an impulse response having a number of channels measured in the room.

Obtaining for the room the geometry of the room may comprise obtaining an indexed list of planar surfaces each comprising a surface area Sᵢ, and metadata indicating the position of the receiver and source within the geometry of the room.

Obtaining for the room the geometry of the room may further comprise obtaining metadata indicating a source directivity pattern.

Determining the room absorption area based on the determined reverberation time parameter and the geometry of the room may comprise: determining a total absorption area from a combination of the surface areas; and determining a room absorption area based on the total absorption area and the determined reverberation time parameter.

According to a second aspect there is provided an apparatus for reproduction of at least one reflection of reverberation in virtual acoustics rendering systems, the apparatus comprising means configured to: obtain for a room, a geometry of the room and at least one spatial room impulse response, wherein the at least one spatial room impulse response is obtained based on a measurement in the room; determine a reverberation time parameter based on the at least one spatial room impulse response; determine a room absorption area based on the determined reverberation time parameter and the geometry of the room; determine at least one parameter of early reflections from the at least one spatial room impulse response based on at least one image source position, wherein the at least one image source position is associated with early reflections of the at least one spatial room impulse response; extract at least one reflection from the at least one spatial room impulse response; extract at least one reflection coefficient based on the extracted at least one reflection for at least one surface of the room; assign absorption coefficients for at least one surface of the room based on the at least one reflection coefficient and the determined room absorption area; and render the at least one early reflection based on the determined absorption coefficients.

The means configured to determine at least one parameter may be configured to determine at least one of: a time of early reflections from the at least one spatial room impulse response based on at least one image source position; and a direction of arrival of early reflections from the at least one spatial room impulse response based on at least one image source position.

The means configured to extract at least one reflection from the at least one spatial room impulse response may be configured to apply a beamforming to the measured at least one spatial room impulse response to extract at least one reflection.

The means configured to obtain for the room, at least one spatial room impulse response may be configured to measure the at least one spatial room impulse response in the room.

The at least one spatial room impulse response may comprise an impulse response having a number of channels measured in the room.

The means configured to obtain for the room the geometry of the room may be configured to obtain an indexed list of planar surfaces each comprising a surface area Sᵢ, and metadata indicating the position of the receiver and source within the geometry of the room.

The means configured to obtain for the room the geometry of the room may be further configured to obtain metadata indicating a source directivity pattern.

The means configured to determine the room absorption area based on the determined reverberation time parameter and the geometry of the room may be configured to: determine a total absorption area from a combination of the surface areas; and determine a room absorption area based on the total absorption area and the determined reverberation time parameter.

According to a third aspect there is provided an apparatus for reproduction of at least one reflection of reverberation in virtual acoustics rendering systems, the apparatus comprising at least one processor and at least one memory storing instructions that, when executed by the at least one processor, cause the system at least to perform: obtaining for a room, a geometry of the room and at least one spatial room impulse response, wherein the at least one spatial room impulse response is obtained based on a measurement in the room; determining a reverberation time parameter based on the at least one spatial room impulse response; determining a room absorption area based on the determined reverberation time parameter and the geometry of the room; determining at least one parameter of early reflections from the at least one spatial room impulse response based on at least one image source position, wherein the at least one image source position is associated with early reflections of the at least one spatial room impulse response; extracting at least one reflection from the at least one spatial room impulse response; extracting at least one reflection coefficient based on the extracted at least one reflection for at least one surface of the room; assigning absorption coefficients for at least one surface of the room based on the at least one reflection coefficient and the determined room absorption area; and rendering the at least one early reflection based on the determined absorption coefficients.

The apparatus caused to perform determining at least one parameter may be caused to perform determining at least one of: a time of early reflections from the at least one spatial room impulse response based on at least one image source position; and a direction of arrival of early reflections from the at least one spatial room impulse response based on at least one image source position.

The apparatus caused to perform extracting at least one reflection from the at least one spatial room impulse response may be caused to perform applying a beamforming to the measured at least one spatial room impulse response to extract at least one reflection.

The apparatus caused to perform obtaining for the room, at least one spatial room impulse response may be caused to perform measuring the at least one spatial room impulse response in the room.

The at least one spatial room impulse response may comprise an impulse response having a number of channels measured in the room.

The apparatus caused to perform obtaining for the room the geometry of the room may be caused to perform obtaining an indexed list of planar surfaces each comprising a surface area Sᵢ, and metadata indicating the position of the receiver and source within the geometry of the room.

The apparatus caused to perform obtaining for the room the geometry of the room may further be caused to perform obtaining metadata indicating a source directivity pattern.

The apparatus caused to perform determining the room absorption area based on the determined reverberation time parameter and the geometry of the room may be caused to perform: determining a total absorption area from a combination of the surface areas; and determining a room absorption area based on the total absorption area and the determined reverberation time parameter.

According to a fourth aspect there is provided an apparatus for reproduction of at least one reflection of reverberation in virtual acoustics rendering systems, the apparatus comprising: obtaining circuitry configured to obtain for a room, a geometry of the room and at least one spatial room impulse response, wherein the at least one spatial room impulse response is obtained based on a measurement in the room; determining circuitry configured to determine a reverberation time parameter based on the at least one spatial room impulse response; determining circuitry configured to determine a room absorption area based on the determined reverberation time parameter and the geometry of the room; determining circuitry configured to determine at least one parameter of early reflections from the at least one spatial room impulse response based on at least one image source position, wherein the at least one image source position is associated with early reflections of the at least one spatial room impulse response; extracting circuitry configured to extract at least one reflection from the at least one spatial room impulse response; extracting circuitry configured to extract at least one reflection coefficient based on the extracted at least one reflection for at least one surface of the room; assigning circuitry configured to assign absorption coefficients for at least one surface of the room based on the at least one reflection coefficient and the determined room absorption area; and rendering circuitry configured to render the at least one early reflection based on the determined absorption coefficients.

According to a fifth aspect there is provided a computer program comprising instructions [or a computer readable medium comprising instructions] for causing an apparatus, for reproduction of at least one reflection of reverberation in virtual acoustics rendering systems, the apparatus caused to perform: obtaining for a room, a geometry of the room and at least one spatial room impulse response, wherein the at least one spatial room impulse response is obtained based on a measurement in the room; determining a reverberation time parameter based on the at least one spatial room impulse response; determining a room absorption area based on the determined reverberation time parameter and the geometry of the room; determining at least one parameter of early reflections from the at least one spatial room impulse response based on at least one image source position, wherein the at least one image source position is associated with early reflections of the at least one spatial room impulse response; extracting at least one reflection from the at least one spatial room impulse response; extracting at least one reflection coefficient based on the extracted at least one reflection for at least one surface of the room; assigning absorption coefficients for at least one surface of the room based on the at least one reflection coefficient and the determined room absorption area; and rendering the at least one early reflection based on the determined absorption coefficients.

According to a sixth aspect there is provided an apparatus for reproduction of at least one reflection of reverberation in virtual acoustics rendering systems, the apparatus comprising means for obtaining for a room, a geometry of the room and at least one spatial room impulse response, wherein the at least one spatial room impulse response is obtained based on a measurement in the room; means for determining a reverberation time parameter based on the at least one spatial room impulse response; means for determining a room absorption area based on the determined reverberation time parameter and the geometry of the room; means for determining at least one parameter of early reflections from the at least one spatial room impulse response based on at least one image source position, wherein the at least one image source position is associated with early reflections of the at least one spatial room impulse response; means for extracting at least one reflection from the at least one spatial room impulse response; means for extracting at least one reflection coefficient based on the extracted at least one reflection for at least one surface of the room; means for assigning absorption coefficients for at least one surface of the room based on the at least one reflection coefficient and the determined room absorption area; and means for rendering the at least one early reflection based on the determined absorption coefficients.

According to a seventh aspect there is provided a non-transitory computer readable medium comprising program instructions for causing an apparatus, for reproduction of at least one reflection of reverberation in virtual acoustics rendering systems, to perform at least the following: obtaining for a room, a geometry of the room and at least one spatial room impulse response, wherein the at least one spatial room impulse response is obtained based on a measurement in the room: determining a reverberation time parameter based on the at least one spatial room impulse response; determining a room absorption area based on the determined reverberation time parameter and the geometry of the room; determining at least one parameter of early reflections from the at least one spatial room impulse response based on at least one image source position, wherein the at least one image source position is associated with early reflections of the at least one spatial room impulse response; extracting at least one reflection from the at least one spatial room impulse response; extracting at least one reflection coefficient based on the extracted at least one reflection for at least one surface of the room; assigning absorption coefficients for at least one surface of the room based on the at least one reflection coefficient and the determined room absorption area; and rendering the at least one early reflection based on the determined absorption coefficients.

According to an eighth aspect there is provided a computer readable medium comprising instructions for causing an apparatus, for causing an apparatus, for reproduction of at least one reflection of reverberation in virtual acoustics rendering systems, to perform at least the following: obtaining for a room, a geometry of the room and at least one spatial room impulse response, wherein the at least one spatial room impulse response is obtained based on a measurement in the room; determining a reverberation time parameter based on the at least one spatial room impulse response; determining a room absorption area based on the determined reverberation time parameter and the geometry of the room; determining at least one parameter of early reflections from the at least one spatial room impulse response based on at least one image source position, wherein the at least one image source position is associated with early reflections of the at least one spatial room impulse response; extracting at least one reflection from the at least one spatial room impulse response; extracting at least one reflection coefficient based on the extracted at least one reflection for at least one surface of the room; assigning absorption coefficients for at least one surface of the room based on the at least one reflection coefficient and the determined room absorption area; and rendering the at least one early reflection based on the determined absorption coefficients.

An apparatus comprising means for performing the actions of the method as described above.

An apparatus configured to perform the actions of the method as described above.

A computer program comprising program instructions for causing a computer to perform the method as described above.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIG. 1 shows a model of room acoustics and the room impulse response;

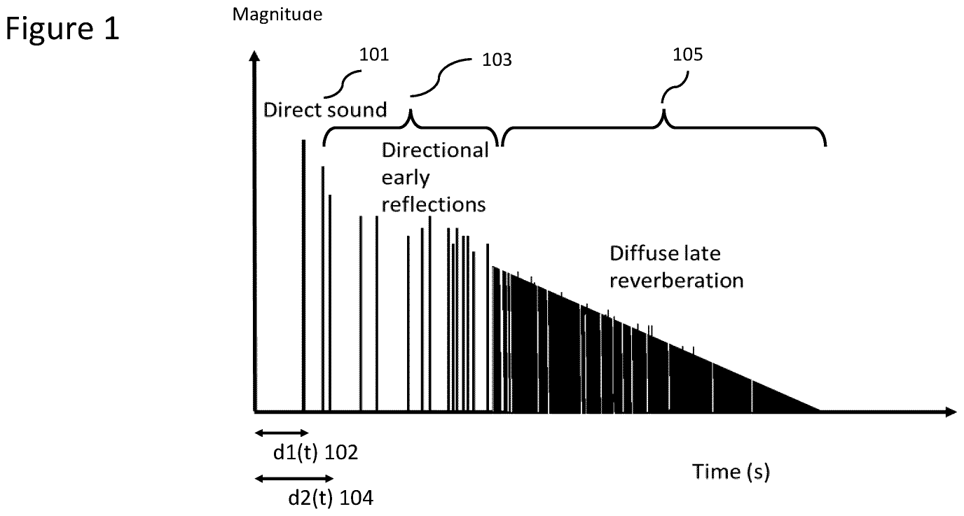

FIG. 2 shows schematically an example apparatus within which some embodiments may be implemented;

FIG. 3 shows a flow diagram of the operation of the example apparatus as shown in FIG. 2;

FIG. 4 shows schematically an example absorption coefficient determiner as shown in FIG. 2 in further detail according to some embodiments;

FIG. 5 shows a flow diagram of the operation of the example absorption coefficient determiner as shown in FIG. 4 according to some embodiments;

FIG. 6 shows schematically an example early reflection parameter processor according to some embodiments;

FIG. 7 shows a flow diagram of the operation of the early reflection parameter processor as shown in FIG. 6 according to some embodiments;

FIG. 8 shows an example environment showing a source and image source geometry with respect to a listener and reflection surfaces;

FIG. 9 shows an example system within which some embodiments can be implemented; and

FIG. 10 shows an example device suitable for implementing the apparatus shown in previous figures.

### EMBODIMENTS OF THE APPLICATION

The following describes in further detail suitable apparatus and possible mechanisms for determining early reflection parameters from spatial room-impulse-responses and room geometry.

As mentioned earlier there is a difference in quality between real capture and acoustic simulation based on current simulation methods. The cause for this disparity between efficient simulation and real capture is the inability to efficiently capture the substantial amount of different effects happening in a room (material and air absorption, diffraction, scattering from wall elements) that contribute to the density and spectral quality of reflections.

For example, typically individual early reflections are filtered with synthetic material filters which are implemented, for example, as low order infinite-impulse-response filters. These filters to some extent emulate the frequency dependent material absorption properties of different materials but more complex acoustic effects are neglected by this approach.

The disparity between efficient acoustic simulation and a real capture has a greater effect with early reflections than with later reverberation as early reflections cause clear comb-filtering when summed in the listener's ears with the direct sound. This allows the listener to perceive the space correctly but also applies a spectral colouration.

It is known that it is possible to measure material or absorption filter parameters from a spatial room impulse response (SRIR) and use the SRIR (and room geometry) to reproduce accurately the spectral coloration caused by a room. Using these methods early reflections can be accurately rendered.

However these methods fail to define the association of the absorption or material filter parameters to portions of a room geometry during the analysis of the parameters but require a separate step of associating the measured parameters to similar provided material characteristics in a room (either based on provided material characteristics in a room or an image).

Thus, current approaches require information that may not be available in many use cases, such as AR rendering. For example a user wanting to capture the characteristics of their room to be used in subsequent AR rendering, requires the user to know the absorption coefficients of the surfaces in the room. Obtaining the absorption coefficients requires significant amount of manual work and measurements, and thus such methods are not suitable for systems that enable the user to adapt their room or enable the user to switch rooms adaptively.

In other words current approaches for determining absorption parameters for early reflection rendering require knowing the absorption coefficients of the surfaces, which is not available without significant manual work. Hence they are not suitable in systems that require capturing reverberation characteristics automatically for spatial rendering of early reflections (e.g., in AR rendering).

Without prior determination assignment of absorption parameters for early reflection rendering to surfaces is arbitrary unless the user provides additional information (such as an image). With an arbitrary assignment of absorptions to walls, the acoustic effect of early reflections is typically not as intended; for example, strong reflections can be perceived originating from a soft (absorbing wall) or visa versa, breaking the immersion effect of the virtual sources being in the room. When a user provides additional information then good audio quality can be achieved but the user thus needs to take additional steps to get the acoustic effect of early reflection synthesis to be functional.

The concept as discussed in the embodiments described in further detail hereafter is one which relates to the reproduction of early reflections of reverberation in (virtual acoustics) rendering systems, where apparatus and methods are provided that can automatically determine absorption coefficients for surfaces of a room based on a spatial room impulse response (SRIR) measured in the room and the geometry of the room. These embodiments subsequently can render early reflections with acoustic properties matching the acoustic properties of early reflections in the room.

This can in some embodiments be achieved by:
determining a reverberation time (for example RT60 time) from the SRIR;
determining at least one room absorption area based on the RT60 and the room geometry;
determining image source positions corresponding to the early reflections from the surfaces based on the room geometry;
determining time and direction of arrival of early reflections on the SRIR based on the image source positions;
applying a beamforming to the SRIR to extract at least one reflection;
extracting reflection coefficients from the reflection for at least one surface;
assigning absorption coefficients for the at least one surface based on the reflection coefficients and the absorption area; and
rendering early reflections using the determined absorption coefficients.

The embodiments as discussed herein attempt to provide an advantage over conventional approaches in that the embodiments can determine the absorption coefficients for the surfaces of the room as an automated process, using the SRIR and the geometry of the room. Hence, the discussed embodiments are suitable for systems requiring automated processing, such as Augmented Reality (AR) rendering.

As a result, realistic rendering of early reflections can be performed by employing the embodiments discussed herein. For example using the proposed methods, the user can “scan” the room where they are, and then have realistic augmented audio objects rendered to them.

When realistic rendering of early reflections is achieved using the proposed embodiments, the user can experience an immersive AR audio scene where virtual sources can be reproduced in the AR audio scene as if they were real physical sources in the space.

As another example, the embodiments describe here can be used on the encoder side of the MPEG-1 Audio rendering system such that a virtual space (or even a physical space) is measured to provide a SRIR, and this SRIR information is then provided to the MPEG-1 Audio encoder which will derive acoustic parameters from it and these parameters are written into the bitstream and used to render audio according to the input space acoustics.

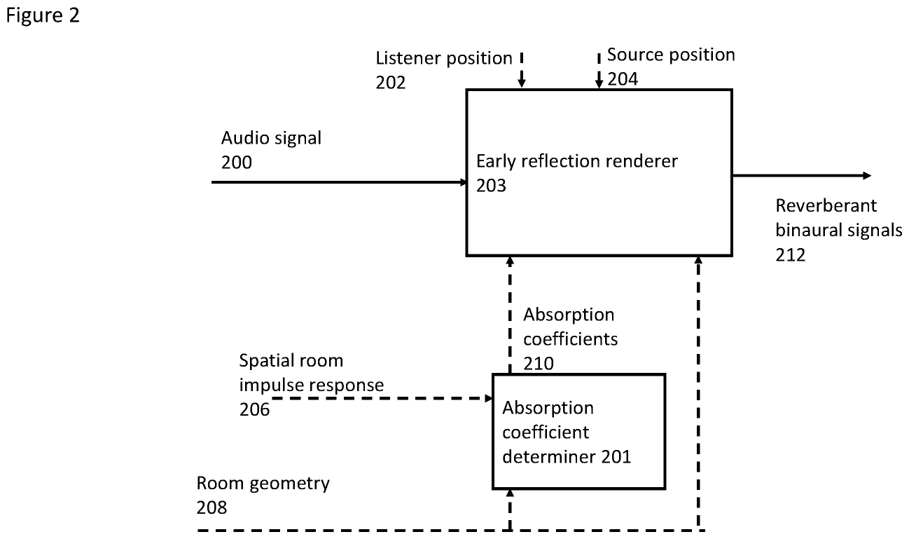

FIG. 2 shows a schematic view of apparatus suitable for implementing some embodiments. The apparatus or system can comprise an absorption coefficient determiner 203 configured to receive as an input a room geometry 208 information and spatial room impulse response 206 information. The absorption coefficient determiner 203 is configured to generate absorption coefficients 210 and pass them to an early reflection renderer 203.

The spatial room impulse response 206 h_{SRIR}(n,j) can comprise impulse responses having j channels measured in a room (where n is time in samples and j the impulse response channel). For example the J channels can be the channels of (first-order or higher-order) Ambisonic room impulse response (which can, e.g., be obtained by measuring the impulse responses using a dedicated microphone, such as Eigenmike).

The room geometry 208 comprises an indexed list of i=1, . . . , I planar surfaces describing the walls, floor, and ceiling of the room. Each such surface has a surface area Sᵢ, with the total area of the room being Sₜₒₜ=Σᵢ Sᵢ.

The room geometry 208 furthermore can comprise metadata indicating the position and optionally orientation or rotation of the receiver and source within the room geometry while doing the measurement of the SRIR.

The room geometry 208 furthermore can comprise metadata indicating source directivity (where it is available). The directivity metadata can provide the source directivity pattern D(θ, k), where θ is the angle to a defined (main) axis of the loudspeaker.

The absorption parameters 204 in some embodiments comprises properties of each surface in the room geometry and are described by an average absorption coefficient αᵢ(k) in k=1, . . . , K frequency bands. In some embodiments the coefficients are described with respect to octave bands with centre frequencies [125, 250, 500, 1000, 2000, 4000]. The absorption coefficient determiner 201 can therefore determine the absorption coefficients 210 αᵢ(k) for each i-th surface in the room.

The apparatus further can comprise an early reflection renderer 203. The early reflection renderer 203 is configured to receive as inputs an audio signal x(n) 200, room geometry 208, listener position 202, and source position 204 and absorption coefficients αᵢ(k) 210. The early reflection renderer 203 is configured to render reverberant binaural signals x_{bin}(n,j_{bin}) 212 as an output, containing early reflections which are perceived equally as if the sound source was actually in the room where the spatial room impulse response 202 was measured. In the following examples the early reflection rendering is described in detail, and direct sound and late reverberation rendering can be considered separately and any suitable direct sound and/or later reverberation rendering methods can be employed.

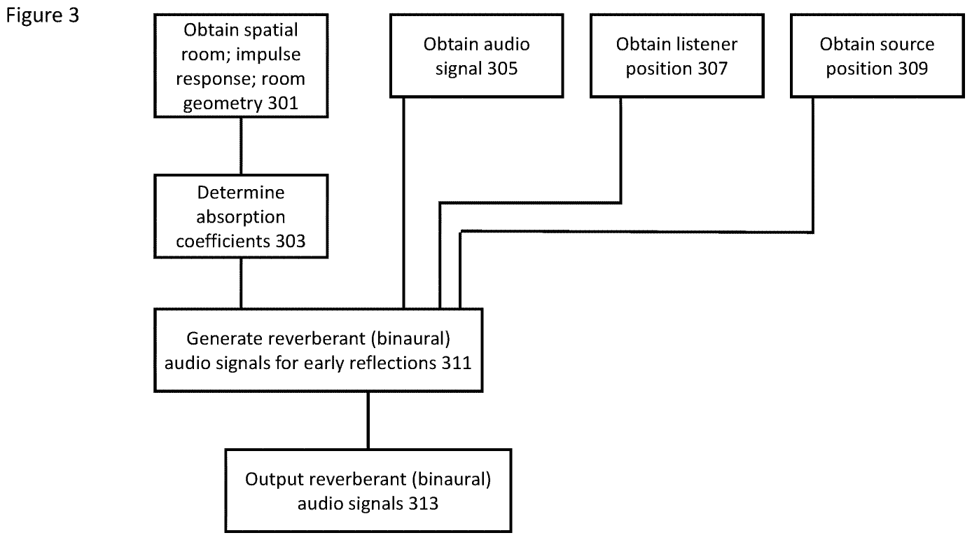

With respect to FIG. 3 is shown an example flow diagram of the operations of the system shown in FIG. 2.

Thus there is obtained the spatial room impulse response and the room geometry as shown by 301.

Then there is the determination of the absorption coefficients from the spatial room impulse response and the room geometry as shown by 303.

Additionally there is the operation of obtaining the audio signal as shown by 305, obtaining the listener position as shown by 307 and obtaining the source position as shown by 309.

Then having determined the absorption coefficients 303 and obtained the room geometry, the audio signal, the listener position and the source position then there is the generation of the reverberant (binaural) audio signals for early reflections as shown by 311.

Then there is the outputting of the generated reverberant (binaural) audio signals for early reflections as shown by 313.

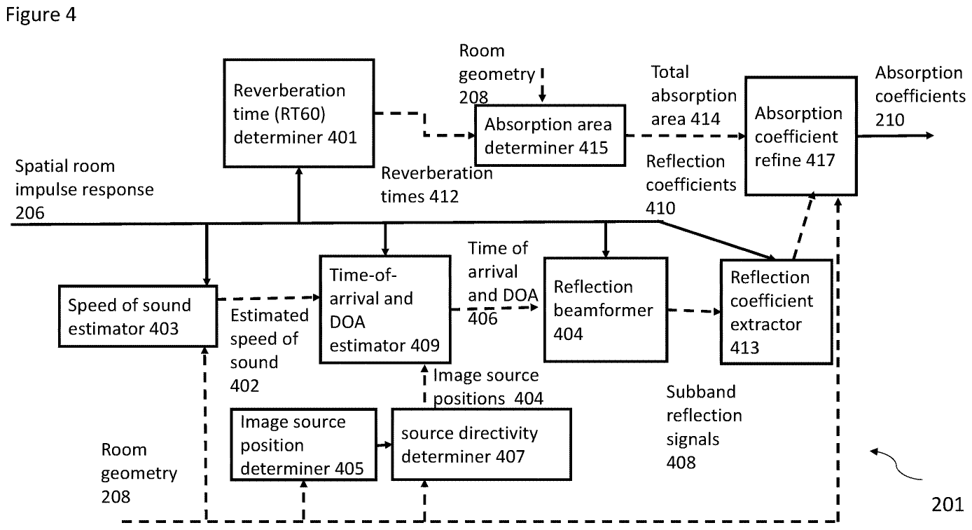

With respect to FIG. 4 is shown a schematic view of the absorption coefficient determiner 201.

The absorption coefficient determiner 201 is configured to receive as input the spatial room impulse response 206 h_{SRIR}(n,j) and the room geometry 208.

The absorption coefficient determiner 201 can comprise a RT60 determiner 401 which is configured to receive the spatial room impulse response 206 h_{SRIR}(n,j) and from these determines the reverberation times 412 T₆₀(k) in at least one frequency band (where k is the frequency band index). The frequency bands can be any suitable band distribution. For example the frequency bands can be octave bands, ERB or Bark bands.

In some embodiments this can be achieved by decomposing the Spatial room impulse response (SRIR) 206 into a number of subbands determined by the desired parameterization. For example this decomposition can be octave bands at [125, 250, 500, 1000, 2000, 4000]. Thus, the SRIR is decomposed into the six respective SRIRs using a suitable octave-band filterbank, resulting in h_{SRIR}(n,k,j), where k is the subband index. The rest of the parameters are computed independently in frequency bands; hence the process is described for one of the subbands.

Assuming that there is access to an omnidirectional representation of the RIR, e.g., the first channel of a B-format SRIR, hₒₘₙᵢ(n,k)=h_{SRIR}(n,k,1), the omni RIR can be processed in order to extract the reverberation time T₆₀(k). The estimation is based on analyzing the energy decay curve EDC(n,k) for an analyzed subband, produced by backwards integrating hₒₘₙᵢ(n,k):

$$EDC ( n , k ) = \frac{1}{E ( k )} {\sum }_{τ = n}^{N} {\vert {h}_{OMNI} ( τ , k ) \vert}^{2} , with$$

$$E ( k ) = {\sum }_{τ = 1}^{N} {\vert {h}_{OMNI} ( τ , k ) \vert}^{2} ,$$

where N is the total length of the SRIR in samples. As the examples and embodiments deal with measured RIRs, there is most likely measurement noise in the SRIR which can bias the estimation of those parameters. The noise power can be estimated from ambience or from the microphones performing the measurement recordings, and is assumed additive, stationary, and uncorrelated with the clean RIR, which results in:

EDC(n,k)=EDC_{RIR}(n,k)+EDCₙₒᵢₛₑ(n,k)

Since the noise is assumed stationary with power per sample Pₙₒᵢₛₑ(k), the modeled noise EDC is linear, and can be given by

EDCₙₒᵢₛₑ(n,k)=(N−n)Pₙₒᵢₛₑ(k)
while the EDC of the RIR is assumed to follow a weighted exponential decay form of the type

$${EDC}_{RIR} ( n , k ) = {B}_{o}^{2} ( k ) [ {e}^{a ( k ) n} - {e}^{- a ( k ) N} ]$$

with the decay rate given by

$$a ( k ) = - \frac{6 ln ( 10 )}{{f}_{s} \cdot RT 60 ( k )}$$

Since the RIR decays below the noise floor after some time, the noise EDC can be computed by some late segment in the measurement, e.g., for t>1 sec in normal rooms. The EDC of that segment can then be assumed to be dominated mainly by the noise term, and a line can be fit to extrapolate the noise EDC across the whole range of the RIR. The denoised EDC_{RIR}(n,k) can then be estimated by subtracting the modeled noise EDCₙₒᵢₛₑ(n,k).

Finally, the denoised EDC is used to estimate the global T₆₀(k), by expressing the EDC in decibels, where the exponential form converts to a linear form. A line can then be fit to the denoised EDC, starting from a time point that avoids the early part (which typically deviates from the exponential model of the later part), e.g., at −5 dB to −10 dB from the maximum of the EDC. The end point can be taken at −20 dB or −30 dB from the first point, and the corresponding time interval between the two is multiplied by 3 or by 2 respectively, to get scaled to T₆₀(k).

The absorption coefficient determiner 201 in some embodiments comprises an absorption area determiner 415. The absorption area determiner is configured to receive the reverberation times 412 T₆₀(k) and the room geometry 208. The absorption area determiner 415 is then configured to determine the total absorption area 414 A(k) for at least one frequency band. The total absorption area 414 corresponds to the sum A(k)=Σᵢ aᵢ(k)·Sᵢ. As an input to the method, the geometry of the room is needed in the form of surface areas Sᵢ, Sₜₒₜ, and potentially the total volume of the room V computed from the dimensions of the room. The method for determining these parameters depends on the type of the room geometry data 208, and the shape of the room. As an example, the Sabine formula can be used:

$$A ( k ) = \frac{0.161 V}{{T}_{60} ( k )} ,$$

which is suitable for diffusive (live) spaces with low absorption and fairly uniform absorption distribution.

Alternatively, the Eyring formula can be employed

$$log ( 1 - \frac{A ( k )}{{S}_{tot}} ) = \frac{0.161 V}{- {S}_{tot} {T}_{60} ( k )} ,$$

which is suitable for spaces with considerable absorption and fairly uniform absorption distribution.

Alternatively, if the room is rectangular, the Fitzroy formula states

$${\sum }_{l = \{ x , y , z \}} \frac{- {S}_{l}}{log ( 1 - {A}_{l} ( k ) / {S}_{l} )} = \frac{{S}_{tot}^{2} {T}_{60} ( k )}{0.161 V} ,$$

where Sₗ₌ₓ=Sₓ₊+Sₓ₋ and Aₗ₌ₓ(k)=aₓ₊(k)Sₓ₊+aₓ₋(k)Sₓ₋ is the total area and total absorption area between opposite surfaces across the x-axis in the room (same for l=y, z for the other two axis). The Fitzroy formula is suitable for large rectangular spaces.

In other cases, other methods may be used, such as numerical methods that may return estimates of the total absorption area from the room geometry and the reverberation time, e.g. as in Lehmann, E. A., & Johansson, A. M. (2008), “Prediction of energy decay in room impulse responses simulated with an image-source model”, The Journal of the Acoustical Society of America, 124(1), 269-277.

In some embodiments, the absorption area determiner 415 can return a high accuracy estimate of the absorption area through brute force search, by e.g. simulating ~100 full image source omni RIRs with 100 different uniform absorption coefficients at every 0.01 values and pick the one that gives the closest RT60 to the measured one.

In all the above cases, an average absorption coefficient per band ā(k)=A(k)/Sₜₒₜ can be estimated and serves as an initial assignment of the same absorption value to all I surfaces, assuming a uniform absorption.

The absorption coefficient determiner 201 can comprise an image source position determiner 405 (or isolated echo detector). The image source position determiner 405 is configured to receive the room geometry 208 and using knowledge of the geometry and spatial information in the SRIR, based on these inputs refine the initial uniform absorption coefficient by extracting individual absorption profiles that correspond to isolated echoes.

In some embodiments the isolated echoes are defined as early echoes that occur in a short time window, for example, about 1.5 msec without the presence of other echoes arriving in the same time window. Typically, these echoes are of most second-order reflections. Processing isolated echoes in the SRIR produces more robust absorption estimates than would be obtained by processing temporal windows with presence of mixed echoes from different directions.

Thus rather than trying to detect the presence of those isolated echoes blindly only from the signals of the SRIR, then prior information coming from the room geometry is employed. In some embodiments the positions of image sources are computed that correspond to such reflections through the image source position determiner 405. The image source position determiner 405 therefore comprises an image source calculator, which determines the image sources and returns the coordinates of the image sources for first-order (and potentially some higher-order) reflections from each surface. The image source calculator can be implemented by any suitable method and is not described in further detail. However some well know methods have been presented, for example, in J. B. Allen and D. A. Berkley, “Image method for efficiently simulating small-room acoustic,” J. Acoust. Soc. Am., vol. 65, pp. 943-950, April 1979 and J. Borish. “Extension of the image model to arbitrary polyhedra.” The Journal of the Acoustical Society of America 75.6 (1984): 1827-1836.

In the image source method, the sound source position is mirrored with respect to each reflecting surface of the room geometry 208 to obtain image sources.

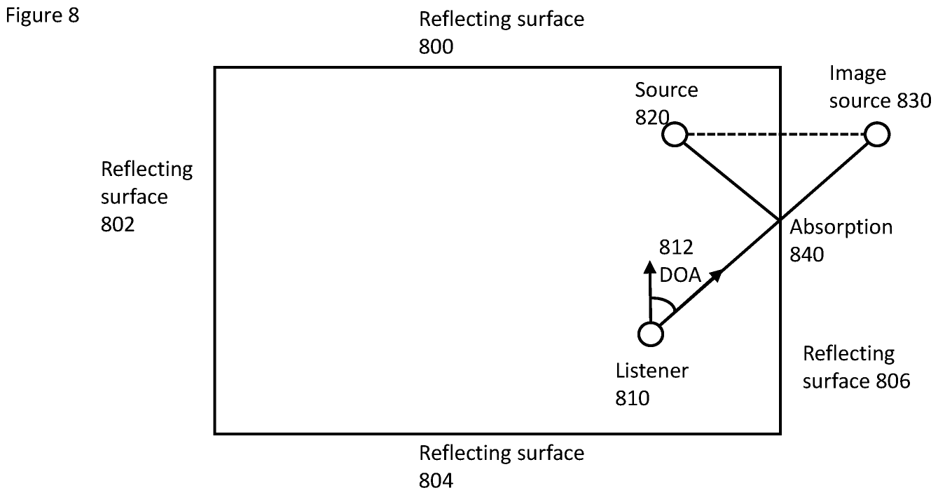

FIG. 8 is shows an example of the mirroring. In the example shown in FIG. 8 the room geometry is a box or rectangular space with reflecting surfaces 800, 802, 804, 806. Within the space is the source 820 and the listener 810. The directions of an early reflection between the source 820 and the listener 810 is shown where on the reflecting surface 806 between the source 820 and listener 810 is a reflection and/or absorption point 840. The mirroring of the Source 820 with regard to the reflecting surface 806 can be used to establish an Image source 830. The line connecting the Image source 830 to the Listener 810 can then be used to establish the reflection and/or absorption point 840 and the direction of arrival (DOA) of the reflection with respect to the listener. The delay to be applied to synthesize an early reflection is obtained based on the distance of the reflecting path (path from the image source to the listener which equals the length of the path from the Source 820 to the Listener 810). The absorption is obtained from the Absorptions αᵢ(k) corresponding to the reflecting surface 806 from which this early reflection is reflected from (the reflection and/or Absorption point 840). The distance attenuation is set proportionally to 1/distance where distance equals the length of the reflection path from the source to the listener. In addition, air absorption can be added to the attenuation. The DOA of an early reflection is set based on the angle of arrival (DOA) from the reflection point to the listener.

First order reflections reflect from a single wall whereas higher order reflections reflect from more than one wall. Higher order reflections can be obtained by using higher-order image sources which are mirrored by each of the reflecting surfaces in turn.

Thus in some embodiments the output of the image source position determiner 405 is a list of image source positions such as [r₀, r₁, . . . , r₁, r_{1,1}, . . . , r_{1,l}, . . . , r_{i,i}, . . . ], where r_{i,i, . . .} =[x_{i,i, . . .} , y_{i,i, . . .} , z_{i,i, . . .} ] are the coordinates of an image source that in each order of reflection has been reflected by the i-th subsequent surface. For example, r₀=[x₀, y₀, z₀] are the coordinates of the actual source with respect to the receiver, while r₁=[x₁, y₁, z₁] are the coordinates of the first-order reflection reflected from surface i=1.

For example in a rectangular room the first order reflections are [r₁, r₂, r₃, r₄, r₅, r₆]. In some embodiments only reflections up to second order reflections are determined excluding the direct path [r₁, . . . , rₗ, r_{1,1}, . . . , r_{1,l}, . . . , r_{l,l}]. Additionally, in some embodiments a list of distances of the image sources [d₁, . . . , d_{I}, d_{1,1}, . . . , d_{1,I}, . . . , d_{1,I}] where d_{i,i, . . .} =∥r_{i,i, . . .} ∥ are determined. In some embodiments each image source in the list is iterated, and by assuming a standard speed of sound in interiors, such as c=343 m/sec, an acoustic distance window of length L=2 msec*343 m/sec~0.69 m, centered at the position of the image source is determined.

In some embodiments if any other image source distance in the list falls inside that window, all such images are removed from the list. The remaining image sources that pass this test are the detected isolated echoes.

In some embodiments, up to two simultaneous reflections can be allowed in a single window centered around each of the two, as long as they are well separated in space. In some embodiment this can be determined based on the angle between the two reflections

$${γ}_{i , {i}^{′}} = a cos ( \frac{{r}_{i} \cdot {r}_{{i}^{′}}}{‖ {r}_{i} ‖ \cdot ‖ {r}_{{i}^{′}} ‖} ) .$$

If γ_{i,i′}>90° then those image sources are considered isolated in a spatiotemporal way.

After the list Pᵢₛₒ of detected isolated image sources has been determined, a final selection stage is applied based on the relationship between their absorption coefficients. Each image source corresponds to the product of absorption coefficients of the surfaces it has been reflected from. If for example the isolated list selection is Pᵢₛₒ=[r₂, r_{1,2}, r₄, r_{6,3}] (ordered based on their distance from the receiver), it corresponds to the absorption coefficients [a₂, a₁·a₂, a₄, a₆·a₃]. From the second-order image sources only the ones that have at least one common absorption coefficient with one of the first-order isolated image sources in the list are kept. For example, from the example list above only the image source r_{1,2} is kept because the image source r₂ is also in the list, allowing computation of the absorption coefficients a₁& a₂. The image source r_{6,3} is not kept since neither of the first-order image sources r₆ or r₃ exist in the list. Hence, the final isolated image echo list after this stage would be Pᵢₛₒ′=[r₂, r_{1,2}, r₄]. From the total i=1, 2, . . . , I room surfaces, the final isolated echoes correspond to a subset I′∈I of surfaces.

This can then be passed to the source directivity determiner 407.

In some embodiments, the absorption coefficient determiner 201 comprises a source directivity determiner 407 configured to receive the room geometry 208 and the image source positions and incorporate within the selection process of isolated echoes to be processed any source directivity effects.

For example if the loudspeaker used during the measurements is not omnidirectional, then some echoes may be too strongly attenuated to be useful in the absorption profile estimation, due to the source directivity.

Thus assuming that the source directivity is known, for example, either from loudspeaker manufacturer specifications or from measurements, that information can be taken into account to exclude suppressed echoes. In some embodiments the source directivity is assumed to be close to axisymmetric. In these embodiment, the directivity can be described as D(φ, k), where φ is the angle to the main axis of the loudspeaker. The main axis can be typically pointing to the “look direction” of the loudspeaker, in other words, where the main drivers are pointing to. Moreover, the orientation of the loudspeaker can be expressed using a vector u that is expressing the direction of the main axis.

In some embodiments the loudspeaker used to capture the SRIR points to the microphone, hence u₀=−r₀/∥r₀∥ is the opposite of the DOA of the loudspeaker. The direction of radiation (DOR) from the source to the receiver θ₀=u₀ coincides with the orientation of the loudspeaker, and the angle between the two vectors is zero, φ₀=∠(θ₀, u₀)=0.

To assess the directional gain of the i-th echo D(φᵢ, k) the source directivity determiner 407 can determine the orientation uᵢ of the image-source loudspeaker and the respective DOR θᵢ The DOR is simply θᵢ=−rᵢ/∥rᵢ∥. The new orientation of the directivity can be given by reflecting the vector u₀ with respect to the reflecting planes of the i-th image source. In the case of a rectangular room, where walls are parallel to xy, yz, zy planes, the image source orientation simplifies to

uᵢ_{ₓ}_{,i}_{_{y}}_{,i}_{_{z}}=[(−1)^{mod(i}^{ₓ}^{,2)}u₀(1),(−1)^{mod(i}^{_{y}}^{,2)}u₀(2),(−1)^{mod(i}^{_{z}}^{,2)}u₀(3)],

where iₓ, i_{y}, i_{z} is the index of the image room on the rectangular image room grid. In other words, the x,y,z coordinate of the original orientation is reflected if the image source corresponds to an odd-order reflection on the respective axis.

Finally, after computing the orientation and DOR of the image source, the directivity angle is provided as φᵢ=∠(θᵢ, uᵢ)=acos(θᵢ·uᵢ), and the directivity value for the k-th band is D(φᵢ, k). The attenuation is compared to a threshold τ. If D(θᵢ, k)/D(0, k)<τ, e.g., with τ=0.5, then the image source is discarded from the list of echoes Pᵢₛₒ, otherwise it is kept.

These image source positions 404 can then be passed to the time-of-arrival and DOA estimator 409.

The absorption coefficient determiner 201 in some embodiments comprises a speed of sound estimator 403. The speed of sound estimator 403 is configured to receive the room geometry 208 and spatial room impulse response 206 and from these generate an estimated speed of sound 402. In order to combine information from the room geometry 208 and the measured SRIR 206, knowledge of the speed of sound c in the measurements is important. Assuming that the distance d₀ between the source and the microphone is known, and any system delays have been removed from the measurement, the time that it took the direct sound to reach the microphone can be determined by finding the sample of the maximum peak in the magnitude of the broadband omnidirectional response |h_{OMNI}(n)|. For increased accuracy, the response can be oversampled, e.g., 8 times, in which case the time traveled of an impulse from the source to the receiver is t₀=n_{direct}/(8fₛ), where n_{direct} is the sampled index of the maximum peak, and fₛ is the original sampling rate.

The speed of sound during the recording conditions can then be determined as

cₑₛₜ=d₀/t₀.

This estimated speed of sound estimate 402 can be passed to the time-of arrival and DOA estimator 409.

In some embodiments the absorption coefficient determiner 201 comprises a time-of-arrival and DOA estimator 409. The time-of-arrival and DOA estimator 409 is configured to receive a list of isolated echo distances coming from the image source position determiner 405 via the source directivity determiner 407 in order to focus at the right spatiotemporal segments in the SRIR and refine the temporal and spatial position estimates of the respective echoes.

The temporal position of each echo in the list

$${P}_{iso}^{′}$$

is refined by forming a temporal window of, e.g., 2 msec centered around the image source time-distance cₑₛₜ·dᵢ. Since in practice the input geometry may not be perfectly aligned with the real room during measurement, the echo time can be re-estimated looking for a sample peak inside that window.

Furthermore in some embodiments, for increased accuracy, oversampling can be performed, for example, 8 times, and the echo time is then

tᵢ=nₚₑₐₖ/(8fₛ).

The direction of arrival (DOA) of each echo can be also refined in the same way. An initial [symbol] of each echo in the list

$${P}_{iso}^{′}$$

can be refined by computing a spatial pseudospectrum in a grid of directions that fall inside a limited spatial window around that initial [symbol] (e.g. of 30° around it). The grid of points can be constructed as, e.g., equiangular with 1° resolution in azimuth and 1° in elevation, and only the grid points that are closer than 30° to the initial [symbol] are retained.

The pseudospectrum can be computed for each of these limited set of points, e.g., by using beamforming steered-response power, or subspace methods such as MUltiple Signal Classification (MUSIC). In some embodiments the index of the grid point with the maximum value indicates the refined DOAᵢ of the echo.

In some further embodiments, where up to two simultaneous reflections may be allowed in a single window centered around each of the two as long as they are well separated in space based on the previously described condition of γ_{i,i′}>90°, the DOA refinement process is performed twice, in a spatial window centered around each of the two DOAs. Two maximum peaks are then selected, one in each spatial window, and the indices of the two grid points indicate the refined DOAᵢ, DOA_{i′} of the two echoes.

The time-of-arrival and DOA estimator 409 is configured to output the refined DOA and time-of-arrival estimates 406 to the reflection beamformer 411.

The absorption coefficient determiner 201 in some embodiments comprises a reflection beamformer 411. The reflection beamformer 411 is configured to better isolate the echo component in the measured SRIR after the refinement of the spatiotemporal information of each isolated echo. Any suitable beamforming structure can be employed for this purpose with a distortionless constraint on the DOA of the echo. The resulting beamforming filters w(n,DOA) can then be used to extract the beamformed SRIR as

$${h}_{beam} ( n ) = {\sum }_{j} {w}_{j} ( n , {DOA}_{i} ) * {h}_{SRIR} ( n , j )$$

In the case of a first-order Ambisonic (FOA) or higher-order Ambisonics (HOA) SRIR, the beamforming weights simplify to

wⱼ(n,DOA)=Yₙₘ(DOA)

where Yₙₘ(DOA) is the order-n and degree-m real Spherical Harmonic value that corresponds to the ambisonic channel j and

$${h}_{beam} ( n ) = {\sum }_{j} {Y}_{nm} ( {DOA}_{i} ) * {h}_{SRIR} ( n , j ) .$$

The beamformed SRIR in some embodiments is further passed through an octave band filterbank, similar to the one used during the reverberation time determiner 401 (the RT60 estimation stage). The subband decomposed beamformed SRIR is then h_{beam}(n,k) for K subbands. After removing the group delay introduced by the filterbank, the subband echo signal can be extracted by selecting, e.g., a ~2 msec temporal window centred around the refined echo arrival time tᵢ

$${h}_{echo}^{( i )} ( n , k ) = {h}_{beam} ( {t}_{i} - \frac{{L}_{win}}{2} : {t}_{i} + \frac{{L}_{win}}{2} , k ) , n = 1 : {L}_{win} + 1 ,$$

where L_{win} is the length of an even-sized window in samples.

In some embodiments where two spatially isolated reflections are allowed in the same time window, the beamforming weights are adapted such that for each of the two reflections there is a distortionless constraint at the direction of one and a null at the direction of the other. The beamforming operation is repeated twice to extract the two echoes' signals, with the null and distortionless constraint exchanged.

The absorption coefficient determiner 201 in some embodiments comprises a reflection coefficient extractor 413 which is configured to receive the refined extracted isolated echo signals, which have been decomposed into subbands, and then used to estimate average power reflection coefficients βᵢ(k) in subbands, which are linked to or associated with absorption coefficients through βᵢ(k)=1−aᵢ(k).

In some embodiments each echo is assumed to be a version of the direct sound signal modified by the absorption filter of the surface it has been reflected from and attenuated by an inverse-distance propagation law. Furthermore assuming that the absorption coefficient is more or less unchanged inside each subband, the relation becomes

$${h}_{echo}^{( i )} ( n , k ) \approx \frac{1}{{c}_{est} \cdot ( {t}_{i} - {t}_{o} )} \sqrt{{β}_{i} ( k )} {h}_{direct} ( n , k ) ,$$

and the reflection coefficient can be estimated as

$${β}_{i} ( k ) = \frac{{c}_{est}^{2} \cdot {( {t}_{i} - {t}_{o} )}^{2} \cdot {\sum }_{n} {( {h}_{echo}^{( i )} ( n , k ) )}^{2}}{{\sum }_{n} {( {h}_{direct} ( n , k ) )}^{2}} .$$

The subband signal of the direct sound h_{direct}(n,k) is extracted in the same manner as the extraction of a single echo (but without beamforming operations, for example by selecting the temporal window around the direct sound arrival time to on the omnidirectional signal hₒₘₙᵢ(n,k).

The extraction first estimates reflection coefficients of the first order reflections in the list

$${P}_{iso}^{′} .$$

Second order echoes if they exist in the list are then used to estimate remaining factors. For example from the second-order echo signal

$${h}_{echo}^{( i , {i}^{′} )} ( n , k ) ,$$

the reflection coefficient product βᵢ(k)·β_{i′}(k) is estimated. Since one of the two first-order echoes (i, i′) should also exist in the list by construction, one of the two reflection coefficients (βᵢ,β_{i′}) is already estimated, and the second one can be computed from the product.

In embodiments where source directivity D(θ, k) is taken into account, and the directivity values for all image sources in the list have been computed in the previous echo selection stage,

$${h}_{echo}^{( i )} ( n , k ) \approx \frac{1}{{c}_{est} \cdot ( {t}_{i} - {t}_{o} )} \frac{D ( {θ}_{i} , k )}{D ( 0 , k )} \sqrt{{β}_{i} ( k )} {h}_{direct} ( n , k ) ,$$

then the extractor can be configured to estimate the reflection coefficient as

$${β}_{i} ( k ) = \frac{{D}^{2} ( 0 , k )}{{D}^{2} ( {θ}_{i} , k )} \frac{{c}_{est}^{2} \cdot {( {t}_{i} - {t}_{o} )}^{2} \cdot {\sum }_{n} {( {h}_{echo}^{( i )} ( n , k ) )}^{2}}{{\sum }_{n} {( {h}_{direct} ( n , k ) )}^{2}} .$$

The extracted absorption coefficients 410 can then be passed to an absorption coefficient refiner 417.

The absorption coefficient determiner 201 in some embodiments comprises an absorption coefficient refiner 417. The absorption coefficient refiner 417 in some embodiments is configured to receive the total absorption area 414, the reflection coefficients 410, the room geometry 208 and generate refined absorption coefficients 210.

In other words after the list of reflection coefficients βᵢ(k) 410 has been estimated for I′≤I surfaces, the respective aᵢ(k)=1−βᵢ(k) absorption coefficients 210 are assigned to the respective I′ surfaces. The newly assigned coefficients change the distribution from the initial uniform absorption distribution ā(k), to a non-uniform one. However, the total absorption area should not change. Hence, the following relation should hold (approximately):

$$A ( k ) = {\sum }_{i ∈ {I}^{′}} {a}_{i} ( k ) {S}_{i} + {\sum }_{i ∉ {I}^{′}} \overline{a} ( k ) {S}_{i}$$

where ā(k) is an average absorption coefficient for the remaining surfaces. The new average absorption coefficient can then be estimated as

$${\overline{a}}^{′} ( k ) = \frac{A ( k ) - {\sum }_{i ∈ {I}^{′}} {a}_{i} ( k ) {S}_{i}}{{\sum }_{i ∉ {I}^{′}} {S}_{i}}$$

Since the total absorption area estimated from reverberation formulas can deviate from the true one, depending on the room properties and reverberation formula in use, a thresholding is used to keep the average absorption coefficient to reasonable values, e.g. ā′(k)=max(0.1, ā′(k)) and ā′(k)=min(0.9, ā′(k)).

In some embodiments, the mean absorption coefficient is assigned to the remaining i∉I′ surfaces (i.e., αᵢ(k)=ā′(k) when i∉I′) that correspond to non-isolated echoes.

The resulting absorption coefficients 210 αᵢ(k) are then output.

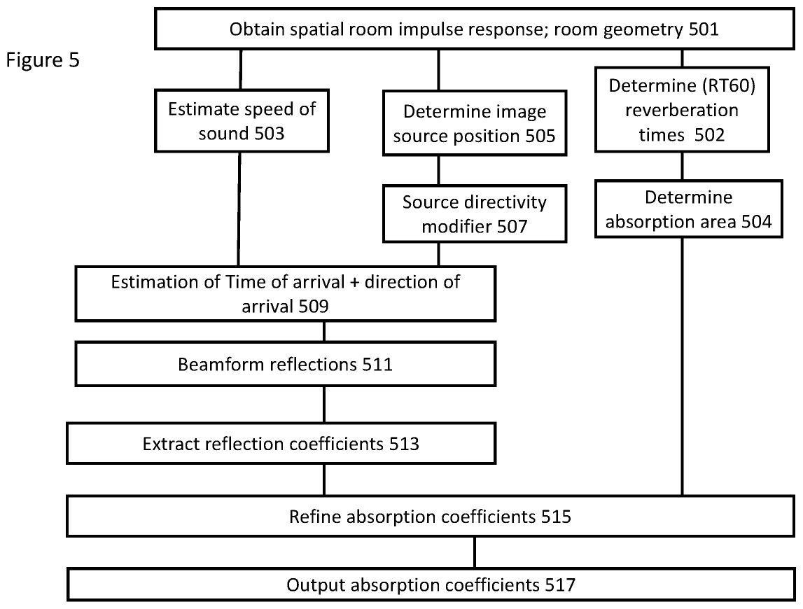

With respect to FIG. 5 is shown a flow diagram of the example absorption coefficient determiner shown in FIG. 4.

Thus is shown obtaining the spatial room impulse response and room geometry in FIG. 5 by 501.

Then is shown the estimating of the speed of sound in FIG. 5 by 503.

Also is shown the determination of image source position in FIG. 5 by 505.

Following the determination of image source position is the modification by the source directivity which is shown in FIG. 5 by 507.

Then is shown the estimation of time-of-arrival and direction-of-arrival which is shown in FIG. 5 by 509.

The reflections can then be beamformed to further extract the echoes from the SRIR as shown in FIG. 5 by 511.

The reflection coefficients can then be extracted as shown in FIG. 5 by 513.

Furthermore is shown in FIG. 5 by 502 a determination of the reverberation (RT60) times.

The reverberation times, with the room geometry can then be used to assist in the determination of the absorption area as shown in FIG. 5 by 508.

Then the absorption coefficients can be refined as shown in FIG. 5 by 515.

The absorption coefficients can then be output as shown in FIG. 5 by 517.

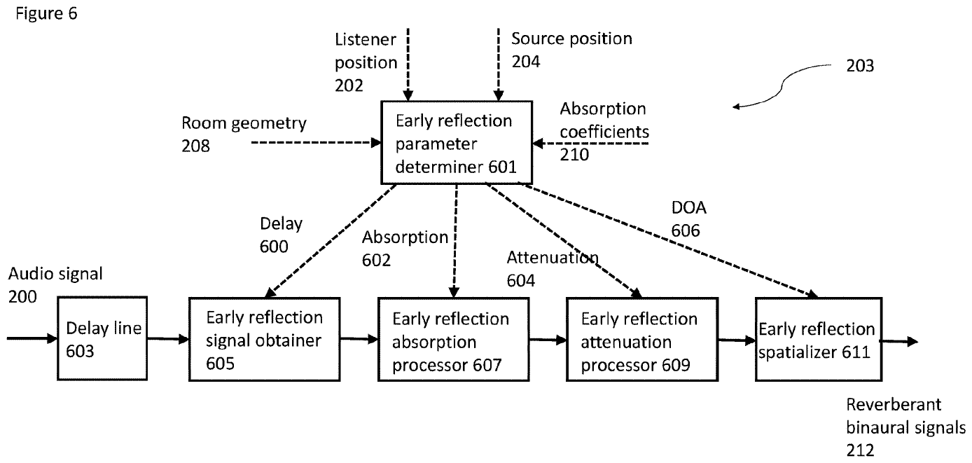

With respect to FIG. 6 is shown in further detail a schematic view of the early reflection renderer 203 suitable for some embodiments. The early reflection rendering uses as inputs the Room geometry 208, Listener position 202, Source position 204, and Absorption coefficients 210 to synthesize reverberant binaural signals 212 (at least one early reflection signal) using the audio signal 200. The input audio signal 200 is first fed into a Delay line 603 which buffers past audio signal samples and enables picking segments of past samples of the audio signal 200.

The early reflection renderer further comprises an early reflection parameter determiner 601 which is configured to use the room geometry 208, Listener position 202, source position 204, and absorption coefficients 210 to determine the parameters for one or more early reflection(s). There are several ways to calculate or simulate early reflections.

There are several ways to calculate or simulate early reflections. As an example, the image source method can be used such as discussed in J. B. Allen and D. A. Berkley, “Image method for efficiently simulating small-room acoustic,” J. Acoust. Soc. Am., vol. 65, pp. 943-950, April 1979 and J. Borish. “Extension of the image model to arbitrary polyhedra.” The Journal of the Acoustical Society of America 75.6 (1984): 1827-1836.

In the example early reflection renderer 203 shown in FIG. 6, is configured to generate control parameters such as delay 600, absorption 602, attenuation 604 and direction of arrival (DOA) 606 and pass these to the processors described hereafter.

The delay 600 to be applied to synthesize an early reflection can in some embodiments is obtained based on the distance of the reflecting path (path from the image source to the listener). The absorption is obtained from the Absorptions αᵢ(k) corresponding to the reflecting surface from which this early reflection reflected from. The attenuation is set proportionally to 1/distance where distance equals the distance traveled by the early reflection. In addition, air absorption can be simulated by appropriate low pass filtering which will attenuate the high frequencies depending on the distance traveled by the reflection.

The early reflection signal obtainer 605 can receive the output of the delay line 603 and the delay 600 parameter. The Early reflection signal obtainer is configured to obtain a past signal sample based on the delay 600 to obtain a delayed signal.

An early reflection absorption processor 607 then can filter the selected past signal sample to apply an equalizer filter to model the Absorptions αᵢ(k) data 602 for the early reflection to obtain a delayed and absorption filtered signal.

An early reflection attenuation processor 609 can then attenuate the delayed and absorption filtered signal by applying a 1/distance attenuation and optionally air absorption based on the attenuation 604 parameter to obtain delayed and absorption filtered and attenuated signal.

Finally, an early reflection spatializer 611 can be configured to spatialize the delayed and absorption filtered and attenuated signal with a HRTF filtering with a left and right HRTF filter corresponding to the desired DOA 606 for this early reflection to obtain a Reverberant binaural signal 212 containing synthesized early reflection portion. In some situations the early reflection spatializer 611 can implement a binauralizer to generate the binaural signal 212.

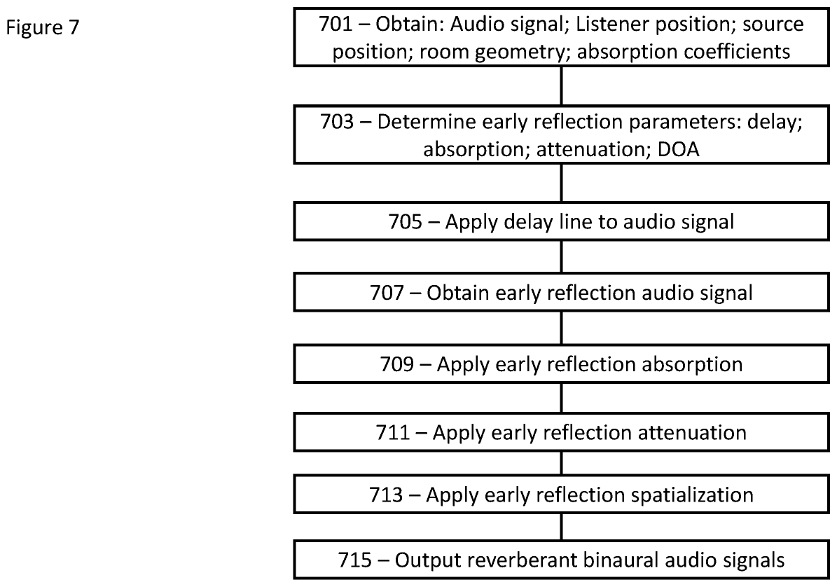

With respect to FIG. 7 is shown a flow diagram showing the operations of the example early reflection renderer 203 according to some embodiments.

Thus as shown in FIG. 7 by 701 there is obtaining: Audio signal; Listener position; source position; room geometry; absorption coefficients.

Then as shown in FIG. 7 by 703 determining early reflection parameters: delay; absorption; attenuation; DOA.

Furthermore as shown in FIG. 7 by 705 is applying a delay line to audio signal.

After this as shown in FIG. 7 by 707 is obtaining an early reflection audio signal.

Furthermore as shown in FIG. 7 by 709 is applying an early reflection absorption to the early reflection audio signal.

As shown in FIG. 7 by 711 is applying an early reflection attenuation to the absorption processed early reflection audio signal.

Then as shown in FIG. 7 by 713 is the applying an early reflection spatialization to the attenuated and absorption processed early reflection audio signal.

Then as shown in FIG. 7 by 715 is the outputting of the reverberant binaural audio signals.

In some embodiments it may be possible that in some room geometries there are no first-order reflections for certain source-receiver location pairs. In such situations, the absorption coefficient cannot be obtained from the first-order reflection using the embodiments discussed above. However an output can be generated using a mean of the absorption coefficients aᵢ(k) of other surfaces. In some embodiments, second-order reflections may be used for computing the absorption coefficient, similarly as presented above for the directional sources.

In the examples presented above, first-order Ambisonic impulse responses were used as an example of the spatial room impulse response. In other embodiments, other kind of impulse responses may be employed. For example, the impulse responses may be from a microphone array attached on a mobile device. In such examples, some details of the embodiment may differ. For example the DOA analysis may be optimized for the mobile device. Thus the methods presented in UK patent application GB1619573.7 can be used for the analysis of DOAs in frequency bands. The method of UK patent application GB1619573.7 was presented for continuous audio, but it in this situation can be applied on the impulse response h_{SRIR}(n,j) (or the time-frequency domain version of it H_{SRIR}(b,n,j)).

In the example embodiment presented above, the computations were implemented in frequency bands k. In some embodiments the computations can also be done in bins b, and the result can be averaged in subbands in a later stage.

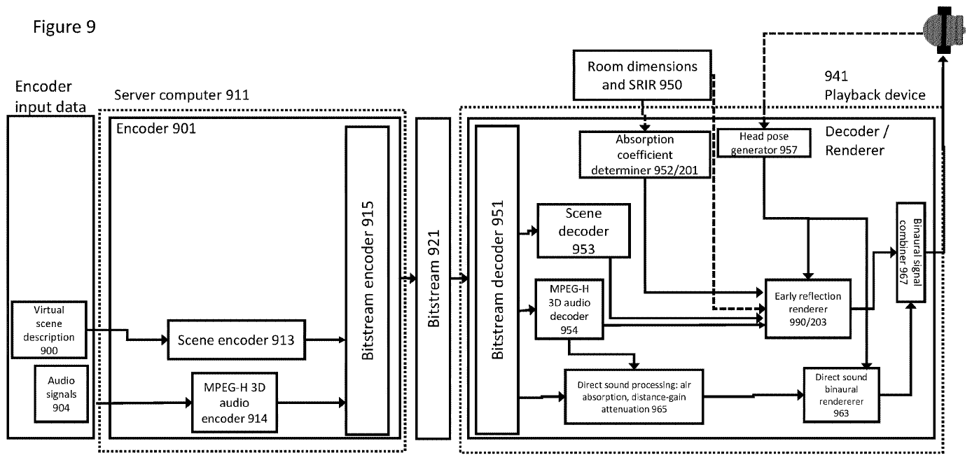

FIG. 9 shows schematically an example system where the embodiments can be implemented. The system comprises an encoder device 1901 as part of a server computer 911 writes data into a bitstream 1921 and transmits that for a renderer/playback device 941, which decodes the bitstream, performs reverberator processing according to the embodiments and outputs audio for headphone listening.

The encoder side 901 of FIG. 9 can be performed on content creator computers and/or network server computers. The output of the encoder is the bitstream 921 which is made available for downloading or streaming. The decoder/renderer functionality runs on the playback device 941, which can be a mobile device, personal computer, sound bar, tablet computer, car media system, home HiFi or theatre system, head mounted display for AR or VR, smart watch, or any suitable system for audio consumption.

The encoder 901 is configured to receive the virtual scene description 900 and the audio signals 904. The virtual scene description 900 can be provided in the MPEG-I Encoder Input Format (EIF) or in other suitable format. Generally, the virtual scene description contains an acoustically relevant description of the contents of the virtual scene, and contains, for example, the scene geometry as a mesh, acoustic materials, acoustic environments with reverberation parameters, positions of sound sources, and other audio element related parameters such as whether reflections are to be rendered for an audio element or not. The encoder 901 in some embodiments comprises a scene and reverberation payload encoder 913 configured to generate reflection parameters.

The encoder 901 further comprises a MPEG-H 3D audio encoder 914 configured to obtain the audio signals 904 and MPEG-H encode them and pass them to a bitstream encoder 915.

The encoder 901 furthermore in some embodiments comprises a bitstream encoder 915 which is configured to receive the output of the scene and reverberation payload encoder 913 and the encoded audio signals from the MPEG-H encoder 914 and generate the bitstream 921 which can be passed to the bitstream decoder 951. The bitstream 921 in some embodiments can be streamed to end-user devices or made available for download or stored.

The decoder/renderer in some embodiments comprises a bitstream decoder 951 configured to decode the bitstream.

The decoder/renderer further can comprise a scene decoder 953 configured to obtain the encoded reverberation parameters and decode these in an opposite or inverse operation to the reverberation payload encoder 913.

Furthermore the head pose generator 957 receives information from a head mounted device 970 or similar and generates head pose information or parameters which can be passed to the early reflection renderer 990/203, and the direct sound binaural renderer 963.

The decoder 941 comprise MPEG-H 3D audio decoder 954 which is configured to decode the audio signals and pass them to the early reflection renderer 990/203 and direct sound processing 965.

Additionally the decoder/renderer 941 comprises a direct sound processor 1965 which is configured to receive the decoded audio signals and configured to implement any direct sound processing such as air absorption and distance-gain attenuation and which can be passed to a direct sound binaural renderer 1963 which with the head orientation determination (from a suitable sensor) can generate the direct sound component which with the reverberant component is passed to a binaural signal combiner 967. The binaural signal combiner 967 is configured to combine the direct and early reflection parts to generate a suitable output (for example for headphone reproduction).

Furthermore in some embodiments the decoder comprises a head orientation determiner which passes the head orientation information to the head pose generator 1957.

In some embodiments, the output is a multichannel loudspeaker setup (such as 5.1 or 7.1+4 multichannel loudspeaker setup). In that case, the processing proposed can be modified by using the loudspeaker positions of the actual loudspeakers as the loudspeaker setup θₗₛ(i), φₗₛ(i), and omitting the binaural renderer, and reproducing the reverberant audio signals from the corresponding loudspeakers of the loudspeaker setup.

Referring to FIG. 9, in the case of loudspeaker output, instead of early reflection renderer 990/203 there will be loudspeaker renderer (or panner) which in the simplest case will just pass through the loudspeaker signals to a loudspeaker signal combiner which will replace the Binaural signal combiner 967. Correspondingly, the direct sound part and early reflection part are spatialized with a panner such as VBAP implemented instead of the binaural processors.

The embodiments can be applied, for example, in AR rendering. In this case, the input to the renderer are the Room geometry information and the SRIR, and the embodiments earlier is executed on the playback device. The SRIR can describe an acoustic measurement associated with the room where the listener is listening to the audio scene. In addition to reverberation rendering, the playback device can perform direct sound rendering and then combine (mix) the direct sound portion and reverberant sound portion. The playback can be head tracked such that the rendered audio is rotated and translated according to the user position in the space where reverberation is rendered.

In the example shown with respect to FIG. 9 only Early reflection rendering is depicted. The complete system can also contain a diffuse (late) reverberation renderer which synthesizes the late reverberation portion. The synthesized late reverberation portion can be binauralized and summed to the binauralized early reflection portion. In some embodiments loudspeaker output is produced via panning instead of binauralization with HRTFs.

In some embodiments the SRIR and room geometry information, including source and receiver positions of the SRIR measurement can be contained in a listening space description for the renderer. The goal of the LSDF interface is to provide suitable information for the renderer to be able to render content matching the real environment for augmented and mixed reality applications.

The LSDF can provide loudspeaker setup parameters which can contain the directivity, position, and orientation of the loudspeaker or other sound source used during SRIR measurement.

The LSDF can contain the following elements for describing the listening space (See MPEG-I Immersive Audio Augmented Reality Listener Space Description Format, Version 2)

| Element | Purpose |
|---|---|
| <AudioScene> | Listening space audio |
| | scene |
| <Mesh>, <Face>, | Describing walls, |
| <Vertex>, | floor and ceiling |
| <AcousticMaterial> | |
| <AcousticEnvironment>, | RT60, rdr |
| <AcousticParameters>, | |
| <Frequency> | |
| <ARAnchor> | Aligning EIF elements to |
| | real-world objects |
| <LoudspeakerSetup> | Defines a loudspeaker |
| | setup for loudspeaker |
| | rendering |

In which:

<AudioScene> declares the listening space.

<Mesh> can be used to describe the listening space (room) geometry. It contains faces and vertices.

<AcousticMaterial> can be used to describe prior information on wall materials.

<AcousticEnvironment> can carry the RT60 and reverberant-to-direct ratio parameters (if available)

<ARAnchor> can be used for aligning virtual content (encoder input format, EIF content) to the listening space.

Furthermore, a new entry <RoomimpulseResponse> can be added. The example description can be as follows:

<AcousticEnvironment> and <AcousticParameters> are as specified in the MPEG-I Encoder Input Format (EIF) with the differences described below. The <AcousticEnvironment> in the LSDF must contain either <AcousticParameters> or <RoomImpulseResponse> but not both.

<AcousticEnvironment>
Declares an acoustic environment. The environment is characterized by
either acoustic parameters or room impulse responses at a number of
points in space. Additionally, a bounding volume can be specified.

| Child node | Count | Description |
|---|---|---|
| <AcousticParameters> | >=0 | Acoustic parameters. See the description in |
| | | the MPEG-I Encoder Input Format. |
| <RoomImpulseResponse> | >=0 | Room impulse response (see below) |

| Attribute | Type | Flags | Default | Description |
|---|---|---|---|---|
| id | ID | R | | Identifier |
| region | Geometry ID | O | none | Region in which properties are specified |

A recording of a spatial room impulse response can be provided instead of acoustic parameters to describe the listening space acoustics. The data of the measurement is carried in <RoomimpulseResponse>:

<RoomImpulseResponse>
Declares a (spatial) room impulse response (SRIR).

| Attribute | Type | Flags | Default | Description |
|---|---|---|---|---|
| id | ID | R | | Identifier |
| file | String | R | | Path of the SRIR audio file |
| format | String | O | B-format | Format of the SRIR data in the file. One of “B- |
| | | | | format”, “Ambisonics”, “mono”. Ambisonics |
| | | | | data can be provided in order from 1st to 4th. |
| micPosition | Position | O | (0, 0, 0) | Position of the SRIR measurement |
| | | | | microphone |
| micOrientation | Orientation | O | (0° 0° 0°) | Orientation of the SRIR measurement |
| | | | | microphone |
| sourcePosition | Position | O | (1, 0, 0) | Position of the source (loudspeaker or other |
| | | | | sound emitter) used during the SRIR |
| | | | | measurement |
| sourceOrientation | Orientation | O | (180° 0° | Orientation of the source (loudspeaker or other |
| | | | 0°) | sound emitter) during the SRIR measurement |
| directivity | Directivity | O | none | Sound radiation pattern of source |
| | ID | | | |

The SRIR in an LSDF can be described using the above example as a B-Format or Ambisonics signal with metadata describing the microphone (mic or receiver) position and orientation. Moreover, position and orientation for the source (loudspeaker used during measurement) is provided. Also, directivity data of the loudspeaker, e.g., as a pointer to a SOFA format file, binary or other file containing the directivity coefficients or a directivity pattern file from which directivity information can be obtained. Such directivity information can in some embodiments be used for compensating for the directivity effects in reflection coefficient calculation.

Note that since the proposed analysis methods produces absorption coefficients for walls it is also possible to define the LSDF interface such that it receives walls with frequency dependent absorption coefficients. In this case, the functionality of receiving a SRIR and analyzing the absorption coefficients from it would be an informative part of the standard and the normative part would start from the LSDF interface.

It is noted that further information can be provided in the above LSDF interface and/or the EIF interface for improving spatial rendering of reverberation. One example is providing RT60 and/or DDR/DSR/RDR values in a spatially dependent manner. That is, there can be more than one RT60 and/or DDR/DSR/RDR per spatial direction in the AcousticEnvironment. For example, in some embodiments there can be four RT60 and/or DDR/DSR/RDR values per four spatial directions, such as 0 degrees, 90 degrees, −90 degrees, and 180 degrees azimuth in an AcousticEnvironment. These values can be used to adjust the directional reverberation characteristics for the AcousticEnvironment reverberator. One method that can be used is to adjust directional output gains for the reverberator such that the directional RT60 values can be approximated.

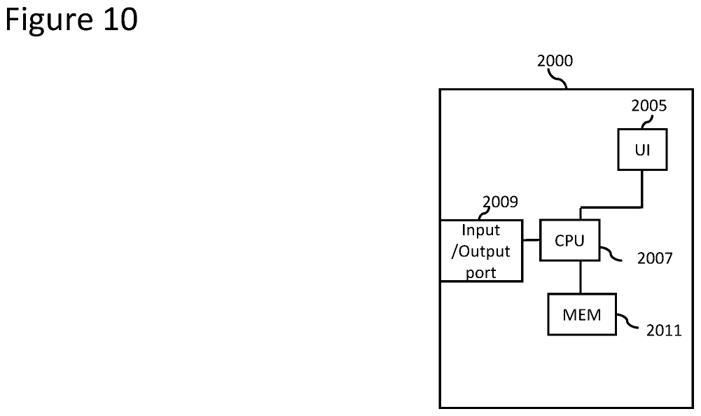

With respect to FIG. 10 an example electronic device which may be used as any of the apparatus parts of the system as described above. The device may be any suitable electronics device or apparatus. For example in some embodiments the device 2000 is a mobile device, user equipment, tablet computer, computer, audio playback apparatus, etc. The device may for example be configured to implement the encoder or the renderer or any functional block as described above.

In some embodiments the device 2000 comprises at least one processor or central processing unit 2007. The processor 2007 can be configured to execute various program codes such as the methods such as described herein.

In some embodiments the device 2000 comprises a memory 2011. In some embodiments the at least one processor 2007 is coupled to the memory 2011. The memory 2011 can be any suitable storage means. In some embodiments the memory 2011 comprises a program code section for storing program codes implementable upon the processor 2007. Furthermore in some embodiments the memory 2011 can further comprise a stored data section for storing data, for example data that has been processed or to be processed in accordance with the embodiments as described herein. The implemented program code stored within the program code section and the data stored within the stored data section can be retrieved by the processor 2007 whenever needed via the memory-processor coupling.

In some embodiments the device 2000 comprises a user interface 2005. The user interface 2005 can be coupled in some embodiments to the processor 2007. In some embodiments the processor 2007 can control the operation of the user interface 2005 and receive inputs from the user interface 2005. In some embodiments the user interface 2005 can enable a user to input commands to the device 2000, for example via a keypad. In some embodiments the user interface 2005 can enable the user to obtain information from the device 2000. For example the user interface 2005 may comprise a display configured to display information from the device 2000 to the user. The user interface 2005 can in some embodiments comprise a touch screen or touch interface capable of both enabling information to be entered to the device 2000 and further displaying information to the user of the device 2000. In some embodiments the user interface 2005 may be the user interface for communicating.

In some embodiments the device 2000 comprises an input/output port 2009. The input/output port 2009 in some embodiments comprises a transceiver. The transceiver in such embodiments can be coupled to the processor 2007 and configured to enable a communication with other apparatus or electronic devices, for example via a wireless communications network. The transceiver or any suitable transceiver or transmitter and/or receiver means can in some embodiments be configured to communicate with other electronic devices or apparatus via a wire or wired coupling.

The transceiver can communicate with further apparatus by any suitable known communications protocol. For example in some embodiments the transceiver can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

The input/output port 2009 may be configured to receive the signals.

In some embodiments the device 2000 may be employed as at least part of the renderer. The input/output port 2009 may be coupled to headphones (which may be a headtracked or a non-tracked headphones) or similar.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general-purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-21. (canceled)

22. A method for reproduction of at least one reflection of reverberation in virtual acoustics rendering systems, the method comprising:
obtaining for a room, a geometry of the room and a reverberation time parameter;
determining a room absorption area based on the determined reverberation time parameter and the geometry of the room;
assigning absorption coefficients for at least one surface of the room based on the determined room absorption area; and
rendering the at least one early reflection based on the determined absorption coefficients.

23. The method as claimed in claim 22, further comprising obtaining at least one spatial room impulse response.

24. The method as claimed in claim 23, wherein the at least one spatial room impulse response is obtained based on a measurement in the room.

25. The method as claimed in claim 23, further comprising determining at least one parameter of early reflections from the at least one spatial room impulse response based on at least one image source position, wherein the at least one image source position is associated with early reflections of the at least one spatial room impulse response.

26. The method as claimed in claim 25, wherein determining at least one parameter comprises determining at least one of:
a time of early reflections from the at least one spatial room impulse response based on at least one image source position; or
a direction of arrival of early reflections from the at least one spatial room impulse response based on at least one image source position.

27. The method as claimed in claim 24, further comprising extracting at least one reflection from the at least one spatial room impulse response with applying a beamforming to the measured at least one spatial room impulse response to extract at least one reflection.

28. The method as claimed in claim 23, wherein the at least one spatial room impulse response comprises an impulse response having a number of channels measured in the room.

29. The method as claimed in claim 22, wherein obtaining for the room the geometry of the room comprises obtaining at least one of:
an indexed list of planar surfaces comprising a surface area, and metadata indicating the position of the receiver and source within the geometry of the room; or
metadata indicating a source directivity pattern.

30. The method as claimed in claim 29, wherein determining the room absorption area based on the determined reverberation time parameter and the geometry of the room comprises:
determining a total absorption area from a combination of the surface areas; and
determining a room absorption area based on the total absorption area and the determined reverberation time parameter.

31. The method as claimed in claim 23, further comprising at least one of:
extracting at least one reflection from the at least one spatial room impulse response; or
extracting at least one reflection coefficient based on the extracted at least one reflection for at least one surface of the room.

32. An apparatus for reproduction of at least one reflection of reverberation in virtual acoustics rendering systems, the apparatus comprising:
at least one processor; and
at least one memory storing instructions that, when executed with the at least one processor, cause the apparatus at least to:
obtain for a room, a geometry of the room and a reverberation time parameter;
determine a room absorption area based on the determined reverberation time parameter and the geometry of the room;
assign absorption coefficients for at least one surface of the room based on the determined room absorption area; and
render the at least one early reflection based on the determined absorption coefficients.

33. The apparatus as claimed in claim 32, wherein the instructions, when executed with the at least one processor, cause the apparatus to obtain at least one spatial room impulse response.

34. The apparatus as claimed in claim 33, wherein the at least one spatial room impulse response is obtained based on a measurement in the room.

35. The apparatus as claimed in claim 32, wherein the instructions, when executed with the at least one processor, cause the apparatus to determine at least one parameter to determine at least one of:
a time of early reflections from the at least one spatial room impulse response based on at least one image source position; or
a direction of arrival of early reflections from the at least one spatial room impulse response based on at least one image source position.

36. The apparatus as claimed in claim 33, wherein the instructions, when executed with the at least one processor, cause the apparatus to extract at least one reflection from the at least one spatial room impulse response with applying a beamforming to the measured at least one spatial room impulse response to extract at least one reflection.

37. The apparatus as claimed in claim 33, wherein the at least one spatial room impulse response comprises an impulse response having a number of channels measured in the room.

38. The apparatus as claimed in claim 32, wherein the instructions, when executed with the at least one processor, cause the apparatus to obtain for the room the geometry of the room at least one of:
an indexed list of planar surfaces comprising a surface area, and metadata indicating the position of the receiver and source within the geometry of the room; or
metadata indicating a source directivity pattern.

39. The apparatus as claimed in claim 38, wherein the instructions, when executed with the at least one processor, cause the apparatus to:
determine a total absorption area from a combination of the surface areas; and
determine a room absorption area based on the total absorption area and the determined reverberation time parameter.

40. The apparatus as claimed in claim 33, wherein the instructions, when executed with the at least one processor, further cause the apparatus to determine at least one parameter of early reflections from the at least one spatial room impulse response based on at least one image source position, wherein the at least one image source position is associated with early reflections of the at least one spatial room impulse response

41. The apparatus as claimed in claim 33, wherein the instructions, when executed with the at least one processor, further cause the apparatus to at least one of:
extract at least one reflection from the at least one spatial room impulse response; or
extract at least one reflection coefficient based on the extracted at least one reflection for at least one surface of the room.
